(19) United States
(12) Patent Application Publication
(10) Pub. No.: US 2006/0121405 A1
(43) Pub. Date: Jun. 8, 2006

(54) Orthodontic arch wire bending system

(76) Inventors: Joseph Hollard, Covington, LA (US); Laurie L. Fricke, Mandeville, LA (US)

Correspondence Address: JOSEPH T. REGARD, LTD PLC, PO DRAWER 429, MADISONVILLE, LA, 70447-0429, US

(21) Appl. No.: 11/005,612

(22) Filed: Dec. 6, 2004

(51) Int. Cl. A61C 3/00

(52) U.S. Cl. 433/3; 433/141

(57) ABSTRACT

A wire bending apparatus for bending an arch wire or the like at its opposing ends and toward the teeth of the user, so as to isolate the loose end and thereby prevent discomfort. The preferred embodiment of the present invention contemplates a device wherein there is provided an elongated body having first and second ends, a pivot piece having a cam associated therewith at the first end, a handle for applying a pushing or pulling force associated with the second end, the handle configured to move along the length of the body, and a drive member running from the handle to the cam, so as to impart linear pressure from the handle to the cam, thereby providing rotational movement at the pivot piece. The handle may be biased via spring or the like, as desired. In use, the end of the arch wire is inserted into a lateral bore formed in the pivot piece, and the handle urged in a direction along the length of the body to impart linear motion to the cam, which converts the linear motion to circular or rotational motion at the pivot piece, the pivot piece engaging and bending the arch wire so that its free end is situated adjacent to the patient's teeth, isolating same. An alternative embodiment contemplates a pliers-like handle configuration wherein the handles may be squeezed toward one another to actuate the pivot piece and bend the arch wire or the like.

### TECHNICAL FIELD OF THE INVENTION

The present invention relates to orthodontic methods and devices, and particularly to a wire bending apparatus for bending an arch wire or the like at its opposing ends and toward the teeth of the user, so as to isolate the loose end and thereby prevent discomfort.

The preferred embodiment of the present invention contemplates a device wherein there is provided an elongated body having first and second ends, a pivot piece having a cam associated therewith at the first end, a handle for applying a pushing or pulling force associated with the second end, the handle configured to move along the length of the body, and a drive member running from the handle to the cam, so as to impart linear pressure from the handle to the cam, thereby providing rotational movement at the pivot piece. The handle may be biased via spring or the like, as desired.

In use, the end of the arch wire is inserted into a lateral bore formed in the pivot piece, and the handle urged in a direction along the length of the body to impart linear motion to the cam, which converts the linear motion to circular or rotational motion at the pivot piece, the pivot piece engaging and bending the arch wire so that its free end is situated adjacent to the patient's teeth, isolating same.

An alternative embodiment contemplates a pliers-like handle configuration wherein the handles may be squeezed toward one another to actuate the pivot piece and bend the arch wire or the like.

### BACKGROUND DISCUSSION OF THE INVENTION

The ends of arch wires emanating from braces are typically either cut a short distance or flush with the bands or the like by the orthodontist. There are pliers specifically configured for cutting distal ends of arch wires so that little if any free ends emanate from the band or the like.

Alternatively, the free opposing ends of the arch wires may be manually bent via pliers or the like to prevent discomfort in the user. However, bending with pliers can cause discomfort in the user, due to having to retract the cheek of the user, as well as forming inconsistent bends in the wire.

Other tools employed by Orthodontists or the like include orthodontic tools for forming twists in arch wires or the like. However, such devices would not be suitable for the bending the free ends or the arch wire in a comfortable and consistent fashion.

Further, while there may be found many different configuration hand tools for bending wire, none are believed to satisfactorily accomplish the task of consistently and without patient discomfort bending free distal ends of the arch wire to isolate same from the user's mouth and tongue.

It is therefore believed there exists a need for a tool for forming a bend in the opposing free distal ends of arch wires or the like, to isolate same from the patient's mouth tissue, in a manner which is consistent and comfortable to the patient.

### GENERAL SUMMARY DISCUSSION OF THE INVENTION

The present invention provides a system for forming a consistent bend in the opposing, free ends of arch wires in a manner which results in minor discomfort in the patient.

The device of the present invention requires little in the way of skill or practice to utilize, and results in a consistent bend to place the free end of the arch wire in the vicinity of the adjacent tooth, so as to isolate said free end from the soft tissue of the user's mouth. The preferred embodiment of the device comprises an elongated body having first and second ends, a pivot piece having a cam associated therewith at the first end, a handle for applying a pushing or pulling force associated with the second end, the handle configured to actuate a drive member running from the handle to the cam, so as to impart linear pressure from the handle to the cam, thereby providing rotational movement at the pivot piece. The handle may be biased via spring or the like, as desired.

In use, the end of the arch wire is inserted into a lateral bore formed in the pivot piece, and the handle urged in a direction along the length of the body to impart linear motion to the cam, which converts the linear motion to circular or rotational motion at the pivot piece, the pivot piece engaging and bending the arch wire so that its free end is situated adjacent to the patient's teeth, isolating same.

An alternative embodiment contemplates a pliers-like handle configuration wherein the handles may be squeezed toward one another to actuate the pivot piece and bend the arch wire or the like.

### BRIEF DESCRIPTION OF DRAWINGS

For a further understanding of the nature and objects of the present invention, reference should be had to the following detailed description, taken in conjunction with the accompanying drawings, in which like parts are given like reference numerals, and wherein:

FIG. 1 is an isometric, side view of the preferred embodiment of the device of the present invention.

FIG. 2 is an isometric, exploded, side view of the device of FIG. 1.

FIG. 3 is a side view of the device of the invention of FIG. 1.

FIG. 4 is a top view of the device of the invention of FIG. 1.

FIG. 5 is a top view of the device of the invention of FIG. 1, illustrating retraction of the handle and rotation of the pivot piece via the cam.

FIG. 6 is a side, exploded, partial view of the second end of the device of FIG. 1.

FIG. 7 is a side view of the retractor handle of the device of FIG. 1.

FIG. 8 is an end view of the end of the retractor handle of the device of FIG. 7.

FIG. 9 is a cross-sectional view of the medial area of the retraction handle of FIG. 8.

FIG. 10 is a top view of the device of FIG. 1, illustrating placement of the device in the patient's mouth for bending of an end of the arch wire.

FIG. 11 is a side view of the first end of the device of FIG. 1, wherein the pivot piece of the device is positioned such that the wire receiving aperture formed in the pivot piece envelopes a portion of the end of the arch wire to be bent.

FIG. 12 is a top, close-up view of the first end of the device of FIG. 1, illustrating the pivot piece rotating to bend the arch wire.

FIG. 13 is a side, partial, close-up view of the device of FIG. 12, illustrating the pivot piece rotating and bending the arch wire.

FIG. 14 is a bottom, partial, close up view of the device of FIG. 13, illustrating the ending of the arch wire by the pivot piece.

FIG. 15 is a top view of the arch wire of FIG. 14, illustrating its bend and position of the end in the vicinity of the molar.

FIG. 16 is a top, partial, close-up view of the first end of the device of FIG. 18, illustrating the movement of the cam and drive member.

FIG. 17 is a side, partial, close-up view of the first end of the device of FIG. 18, illustrating the positioning of the pivot piece with relation to the cam and drive member.

FIG. 18 is a top view of an alternative embodiment of the device of FIG. 1, wherein there is provided pliers-type handle actuation.

### DETAILED DISCUSSION OF THE INVENTION

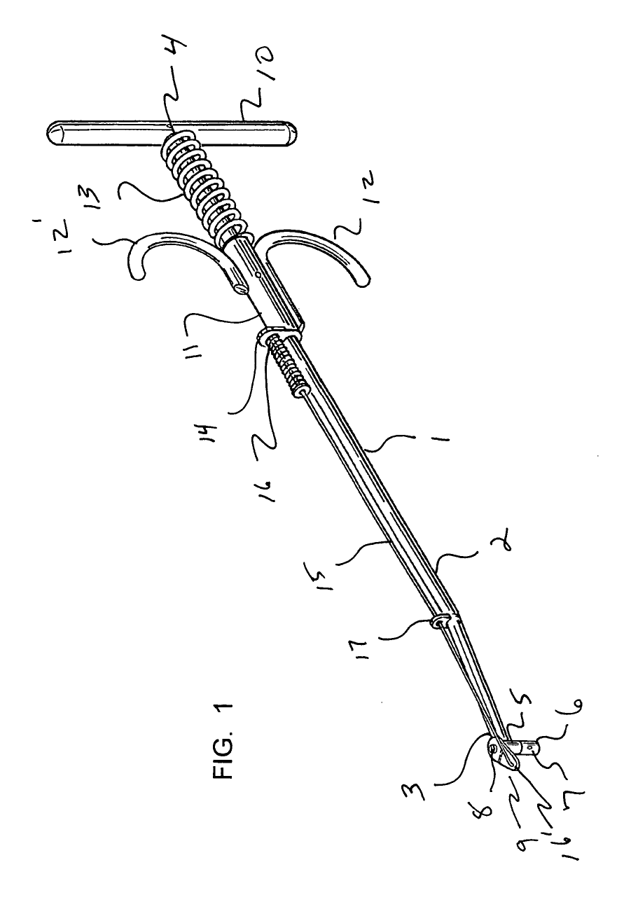

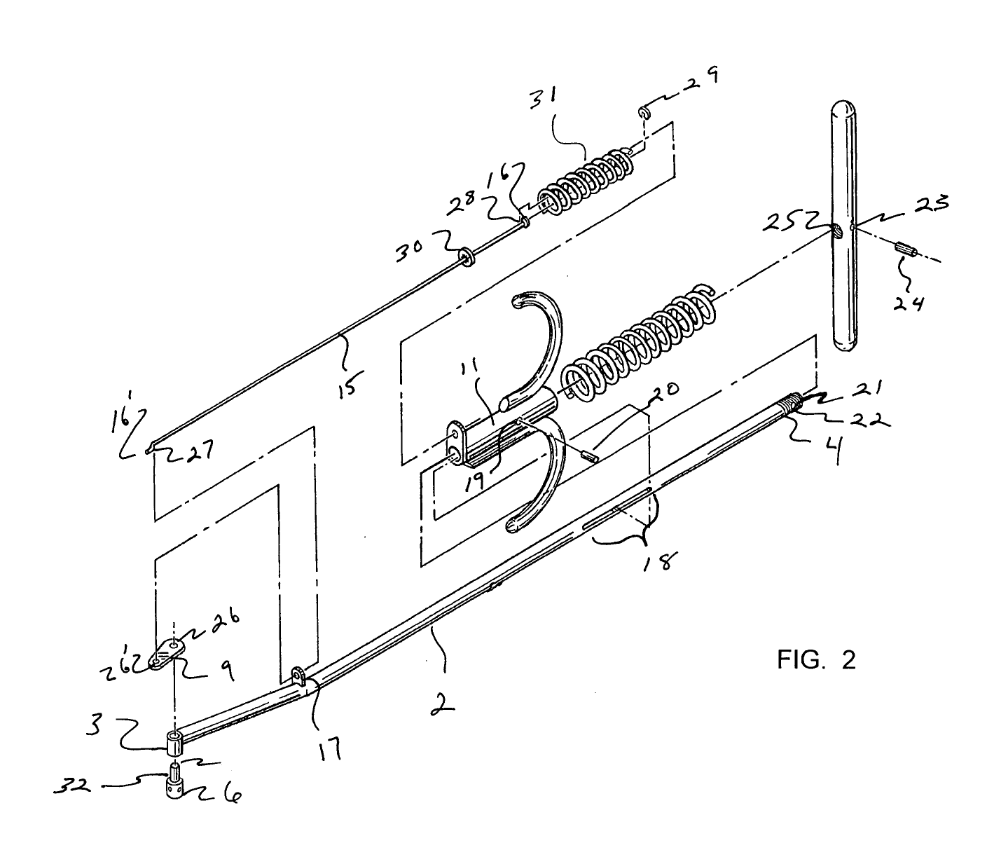

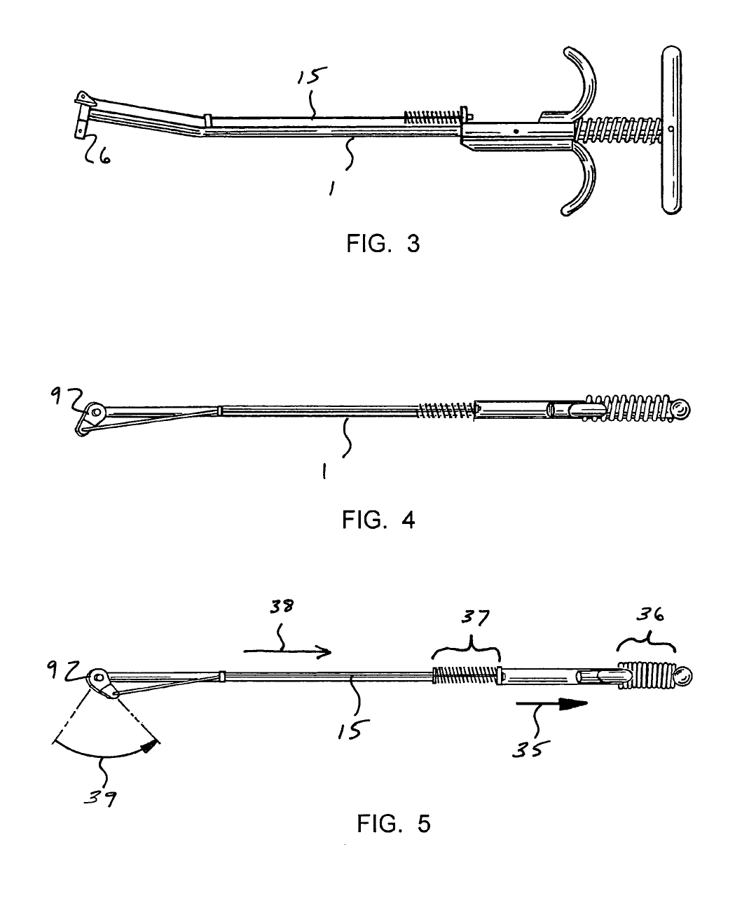

Referring to FIGS. 1-9 of the drawings, the preferred embodiment of the device 1 of the present invention comprises an elongated body 2 formed, from example, a rod of stainless steel or the like, having first 3 and second 4 ends, the first end 3 having a lateral sleeve 5 situated thereon, the sleeve having a pivot piece situated therein and emanating therethrough at one end, and a cam 9 engaging the distal end 8 of the pivot piece via pin emanating the opposing end. The pivot piece 6 has a arch wire receiving aperture 7 laterally formed therethrough.

The second end 4 of the elongated body 2 has a stop 10 medially engaged thereto in the form of a lateral rod. A sleeve 11 slidingly enveloping the elongated body 2 is provided in the vicinity of the second end, the sleeve having emanating therefrom at opposing upper and lower sides are first 12 and second 12′ handles for applying pulling action as will be further disclosed herein. A spring 13 is provided between stop 10 and sleeve 11 to provide spring bias to sleeve.

Sleeve 11 further includes an interface piece 14 mounted thereto, which is configured to engage the first end 16 of drive member 15, shown comprising a slender, elongated rod, for applying pulling and pushing force from sleeve 11 to cam 9. The interface piece 14 has formed therein an aperture 16′ for receiving and engaging the first end 16 of drive member 15, while cam 9 has a lateral aperture 9 for receiving and rotatably engaging the second end 16′ of the drive member 15. A guide 17 may be provided along the body having an aperture for slidably receiving the drive member 15, in order to support same along the length of the elongated body 2.

The first end 16 of the drive member 15 engages sleeve 11 at drive member receiving aperture 14′ at interface 14, and is locked thereto via locking piece 29. A spring 31 is provided at the other side of interface 14 having the drive member running therethrough, the spring situated along its length when not in use and held in place via grommet 13 engaged to drive member 15 so apply bias to hold the locking piece 29 and the first end 16 of drive member adjacent to interface 14 at aperture 14′.

The cam 9 further has formed therein a central aperture 26 for engaging the end 8 of pin 32 emanating from pivot piece 6, said pin rotatably supported by lateral sleeve 5. Cam 6 further has an extended aperture 26′ to pivot cam 6, which aperture 26′ engages the second end 16′ of drive member 15, for example, via bend 27 passing through aperture 26′.

To limit the travel of slide 11 along elongated body 2, a slot 18 is formed laterally therethrough, which slide 11 engages via pin 20 passing through lateral bore 19 through slot. Slot may comprise, for example, 2 centimeters in length.

Stop 10 may be affixed to the second end 4 of elongated body 2 via threaded connection comprising threaded end 22 engaging threaded bore 25 and may be secured via pin 24 passing through bore 23 in stop 10 and bore 21 in elongated body 2.

In operation, one grasps the device such that the stop 19 rests generally in the hand or palm area of the user, with one or more fingers grasping the handles 12, 12′. Pulling 35 the handles towards the stop retracts 38 drive member, pulling cam and causing pivot piece 6 to radially pivot 39, while compressing spring 36. Spring bias from spring 36 urges the handless and slide back to its resting position upon the easing of force on the handles, while spring 31 urges drive member and cam back to the ready position.

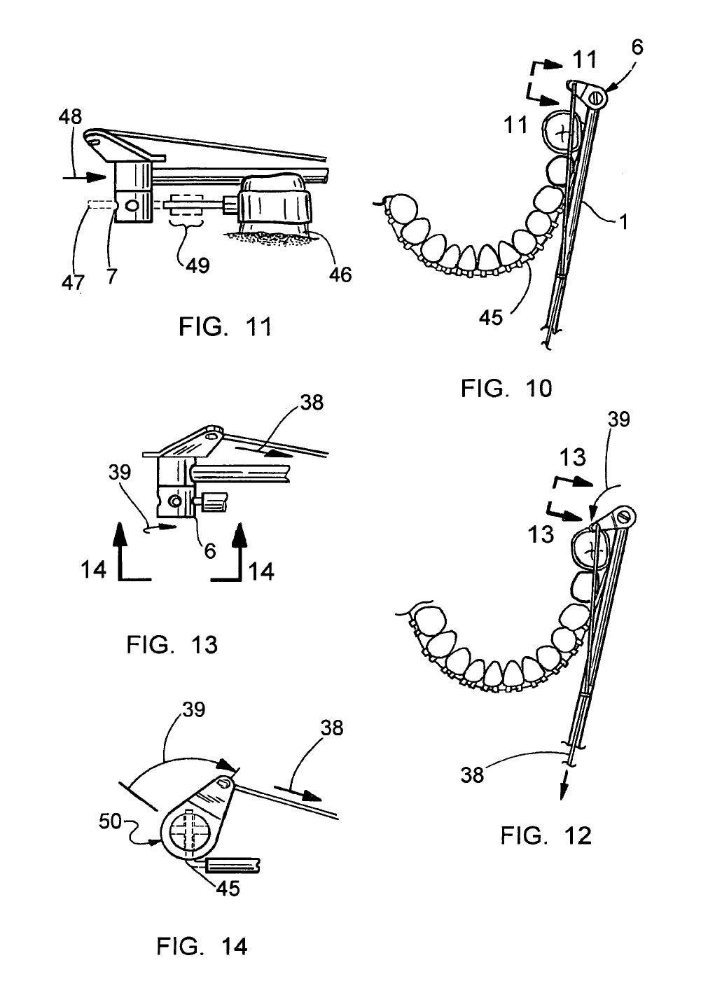

Referring to FIGS. 10-15, in use, the user places the pivot piece 6 at the first end of the unit in the vicinity of the end of the arch wire 45 to be bent, aligns the aperture 7 in the pivot piece 6 with the end 47 of the arch wire, and slides 48 the pivot piece along the arch wire until it reaches a point 49 on the arch wire adjacent to the nearest bracket, molar 46 or tooth. The user then pulls the handles toward the stop of the device in the manner discussed above, retracting 38 drive member, causing pivot piece 6 to radially pivot 39 generally toward the and behind the nearby band, molar 46 or tooth, causing a bend 50 to form behind said tooth, molar, or tooth, the cam preferably passing above said tooth to avoid contact, as in FIG. 12.

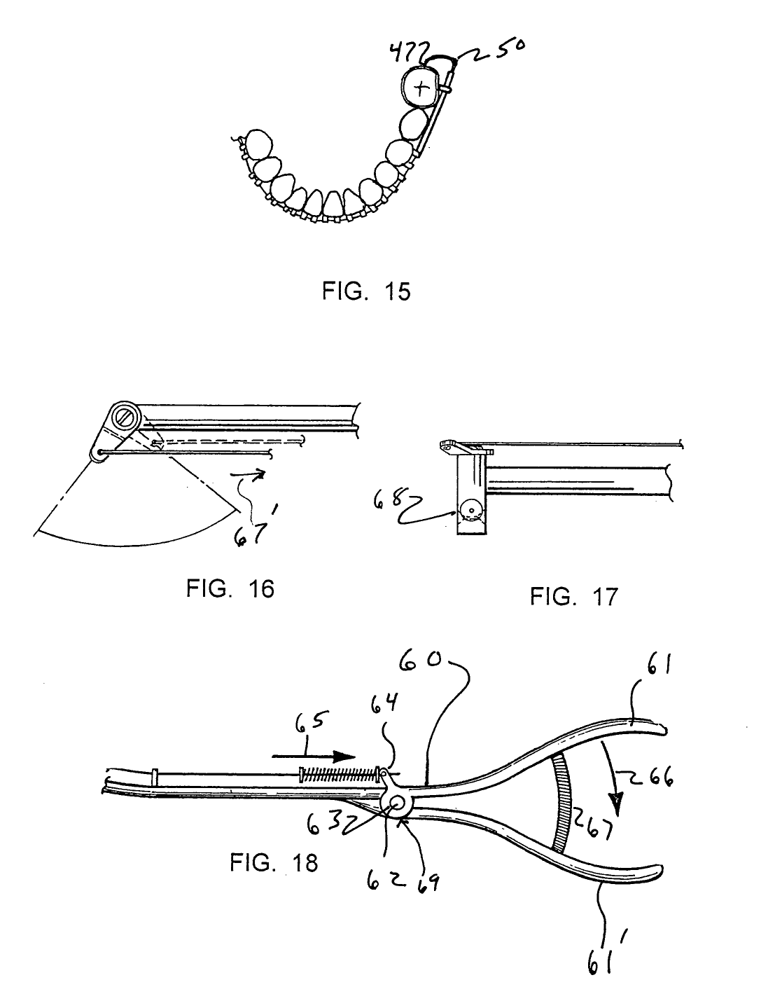

The result is a bend as shown in FIG. 15, wherein the arch wire has a bend 50 formed therein such that the end 47 is isolated behind the adjacent molar, tooth, or band, and positioned in such as manner as to avoid irritating the soft tissues and tongue of the mouth.

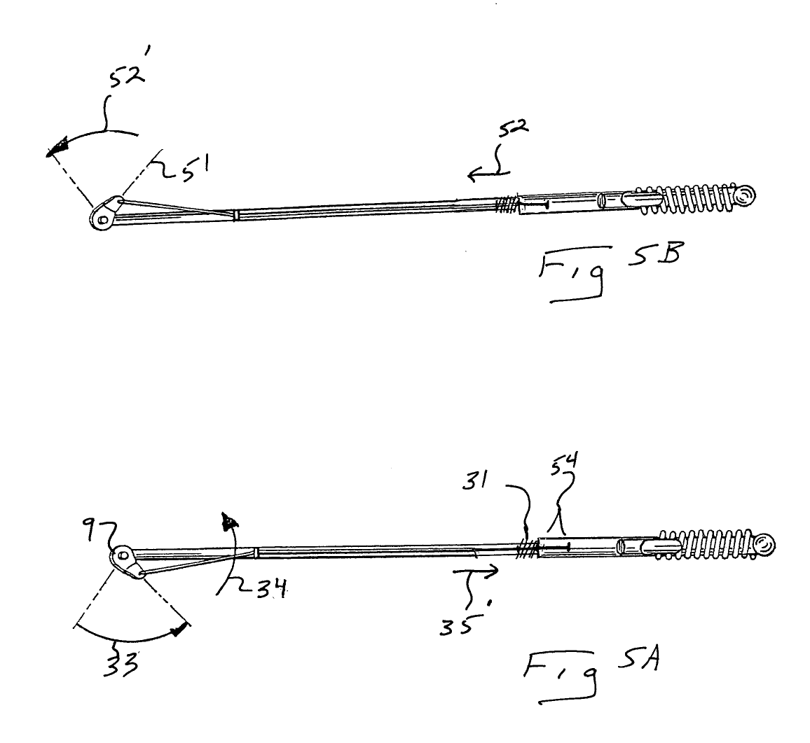

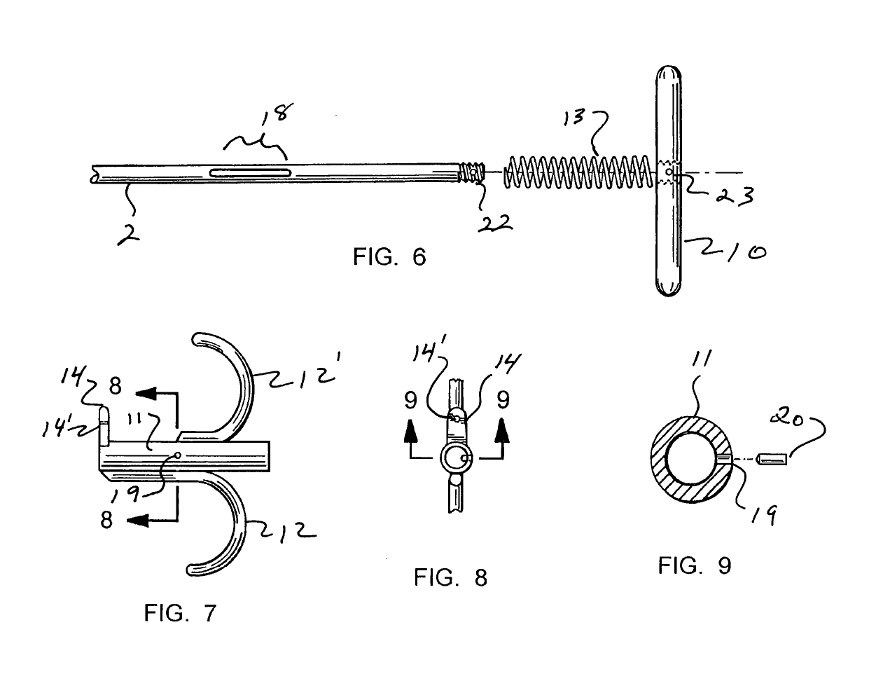

An additional feature of the present invention is illustrated in FIGS. 5A and 5B, which allows the cam to be re-positioned to an opposing orientation to facilitate pivoting to the left or the right, as is necessary for operation to bend the wire at either side of the mouth of the patient. As shown, the cam 9 may be positioned from the left hand orientation of FIG. 5A to the right hand bending orientation of FIG. 5B by manually urging the cam piece toward 33 the spring 31 and further pivot 34 the cam so that it is oriented at the position of FIG. 6B. This manual repositioning compresses 35′ the spring while allowing the first end of drive member to slide through and project beyond 54 sleeve interface, until the cam is positioned 51 at the opposite side, whereupon the spring bias 52 urges 52′ the cam to its ready position and the drive member retracts back such that the locking piece 29 contacts sleeve interface 14.

A second, alternative embodiment of the present invention is illustrated in FIGS. 16-18, which functions and is utilized in a manner similar to the preferred embodiment above, but which includes plier-type grips which are squeezed towards one another, as opposed to the longitudinally actuated grips of the preferred embodiment.

As shown, the pliers embodiment 60 has first 61 and second 61′ handle members, the first handle member situated on a pivot 62 having a cam 63 mounted thereto, such that pressing 66 the handles 61, 61′ together pivots a cam 63, which cam engages 64 the first end of the drive member to pull 65 same, actuating 67′ cam which rotates pivot piece 68 in the manner discussed in the preferred embodiment, supra. Its utilization would be the same as that set forth in the discussion of FIGS. 10-15, above, but for the pliers actuation as opposed to the longitudinal handle action of the preferred embodiment.

### EXEMPLARY SPECIFICATION OF THE PREFERRED EMBODIMENT

Material: Stainless Steel

Length of elongated body: 8″

Diameter of elongated body: ⅛″

Length of drive member: 4¾″

Diameter of drive member: ⅛″

Length of sleeve: 1½″

Length of pivot piece: ½″ (top to bottom)

Diameter of pivot piece: ⅛″ (at widest point)

Inner diameter of arch wire receiving aperture in pivot piece: about 1 mm (should be greater ID than OD of arch wire)

Length of travel of sleeve during actuation: about ½″

Amount of rotation in pivot during actuation (in degrees) about 90 degrees (¼ turn).

### ELEMENTS OF THE INVENTION

| Element | Description |
|---|---|
| 1 | System |
| 2 | elongated body |
| 3 | first end |
| 4 | second end |
| 5 | lateral sleeve |
| 6 | pivot piece |
| 7 | lateral arch wire receiving aperture |
| 8 | distal end |
| 9 | cam |
| 10 | stop |
| 11 | sleeve |
| 12, ′ | opposing handles |
| 13 | spring |
| 14, ′ | interface, drive member receiving aperture |
| 15 | drive member |
| 16, ′ | second, first end |
| 17 | guide |
| 18 | slot |
| 19 | lateral aperture |
| 20 | pin |
| 21 | lateral aperture |
| 22 | threaded |
| 23 | lateral aperture |
| 24 | pin |
| 25 | threaded aperture |
| 26′ | cam pivot piece aperture, drive member aperture |
| 27 | bent end |
| 28 | grommet |
| 29 | locking piece |
| 30 | grommet |
| 31 | spring |
| 32, ′ | pin, end |
| 33 | urge |
| 34 | pivot |
| 35, | retract, compress |
| 36 | compression of spring 13 |
| 37 | extension of spring 31 |
| 38 | pulls |
| 39 | rotation |
| 45 | arch wire |
| 46 | tooth |
| 47 | end |
| 48 | positioned |
| 49 | pivot piece envelopes arch wire in vicinity |
| | of tooth 47 |
| 50 | bends |
| 51 | position |
| 52, ′ | urges, spring bias |
| 54 | projects beyond |
| 60 | Pliers embodiment |
| 61, ′ | first and second handle members |
| 62 | pivot |
| 63 | cam |
| 64 | drive member engagement |
| 65 | pull |
| 66 | press |
| 67, | spring, pull |
| 68 | pivot piece |

The invention embodiments herein described are done so in detail for exemplary purposes only, and may be subject to many different variations in design, structure, application and operation methodology. Thus, the detailed disclosures therein should be interpreted in an illustrative, exemplary manner, and not in a limited sense.

What is claimed is:

1. A wire bending apparatus, comprising:
an elongated body having first and second ends;
a pivot point rotatingly engaged to said first end of said elongated body, said pivot point having a lateral bore formed therein for receiving a wire, said pivot point engaging a cam;
actuation means associated with said second end of said elongated body;
a drive member having first and second ends, said first end of said drive member engaging said cam, said second end of said drive member engaging said actuation means;
whereby said actuation means pivots said cam via longitudinal movement of said drive member, causing said pivot piece to rotate so as to bend any wire situated in said lateral bore formed therein.

2) The wire bending apparatus of claim 1, wherein said actuation means comprises a slide member slidably engaging said elongated body, said slide member having a handle emanating therefrom, said slide member engaging said second end of said drive member, whereby upon said slide member being urged longitudinally along said elongated body, said drive member longitudinally moves to urge said cam to pivot, rotating said pivot piece, and bending any wire situated in said lateral bore formed therein.

3) The wire bending apparatus of claim 2, wherein said actuation means further comprises a stop associated with said second end of said elongated body, and spring bias situated juxtaposed between said slide member and said stop, whereby directing said slide from a first resting position toward said stop via said handle compresses said spring bias while simultaneously urging said cam to pivot via said drive member, pivoting said pivot piece, and releasing said slide member causes said spring bias to urge said slide to said first resting position.

4) The wire bending apparatus of claim 1, wherein said actuation means comprises first and second pliers handles, said first pliers handle engaging said elongated body via a pivot point engaging a pliers cam, said pliers cam engaging said second end of said drive member, whereby pivoting said pliers handle pivots said pliers cam, imparting longitudinal motion to pivot said cam at said first end of said elongated body, rotating said pivot piece, and bending any wire situated in said lateral bore formed therein.

5) The wire bending apparatus of claim 4, wherein said pliers handles have spring bias situated therebetween, whereby directing said pliers handles from a first resting position toward one another compresses said spring while simultaneously urging said cam at said first end of said elongated body to pivot via said drive member, pivoting said pivot piece, and bending any wire situated in said lateral bore formed therein.

6) The method of bending the end of an arch wire in a patient's mouth utilizing the device of claim 1, comprising the steps of:
a) placing the first end of said elongated body of said device in the patients mouth such that said pivot piece is in the vicinity of the end of the arch wire;
b) aligning said aperture in said pivot piece with the end of the arch wire, and sliding the end of the arch wire through said pivot piece until the pivot piece is situated adjacent to a tooth;
c) using said actuation means to retract said drive member, pivoting said cam in the direction of said tooth, pivoting said pivot piece so as to bend said wire at said pivot piece, such that the end of the arch wire is adjacent to the tooth and isolated from the patient's soft tissues and tongue.

7) The method of claim 6, wherein in step (c) said actuation means comprises the apparatus of claim (2), and wherein there is further provided the step of:
i. using said handle to urge said slide member longitudinally along said elongated body toward said second end of said elongated body, imparting longitudinal motion to said drive member so as to pivot said cam at said first end of said elongated body, pivoting said pivot piece.

8) The method of claim 6, wherein in step (c) said actuation means comprises the apparatus of claim (4), and wherein there is further provided the step of:
i. Pivoting said pliers handle, pivoting said cam, imparting longitudinal motion to said drive member to pivot said cam at said first end of said elongated body, rotating said pivot piece.
